(19) United States
(12) Patent Application Publication
(10) Pub. No.: US 2005/0041288 A1
(43) Pub. Date: Feb. 24, 2005

(54) Polarization conversion module and polarization conversion method thereof

(76) Inventor: Liu Liang Liao, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/642,788

(22) Filed: Aug. 19, 2003

(51) Int. Cl. G02B 21/06

(52) U.S. Cl. 359/485; 359/494; 353/20

(57) ABSTRACT

A polarization conversion module uses a convex lens to receive and parallel the incident light passing therethrough. A polarization beam splitter is provided for receiving and polarizing the paralleled incident light transmitted from the convex lens. The polarization beam splitter splits the paralleled incident light into two parts, one of which penetrates through the polarization beam splitter, and the other part of which is reflected by the polarization beam splitter. A phase transformation device is provided for receiving the polarized light penetrating through the polarization beam splitter and transforming the phase of the polarized light passing therethrough, thereby generating phase-shifted polarized light. A mirror is provided for reflecting the reflected polarized light from the polarization beam splitter.

### BACKGROUND OF THE INVENTION

1. Field of the Invention

The present invention relates to a polarization conversion module. More particularly, the present invention relates to a polarization conversion module suited for liquid crystal projection systems.

2. Description of the Related Art

Projection systems come in many different shapes and sizes, ranging from small area, portable head mounted to large area cinema systems. Currently, two of the fastest growing markets for projection systems are business data projectors and home theatre systems. These markets impose stringent demands on the portability, weight, brightness and/or price of the projection system. The projection systems that currently dominate the market are based either on emissive devices, for example cathode ray tubes, or light-modulating devices, such as liquid crystal displays and electromechanical devices. Liquid crystal projectors are generally cheaper and offer higher resolution than projection systems utilizing electromechanical devices. Furthermore, LCD projectors do not suffer the unwanted “color artifacts” inherent with electromechanical device projectors.

LCD projectors use one or more liquid crystal displays to modulate the light generated by a lamp. A bright state on a projector screen is achieved by switching a pixel within the LCD panel ‘on’, thereby allowing the light to travel through the panel and on to the screen. A black state is achieved by switching a pixel ‘off’ and blocking the passage of light. Full color can be produced using either a single panel, which modulates red, green and blue, or multiple panels (usually three) with each individual panel providing the modulation for a particular primary color.

In the projector, the lamp emits un-polarized light whereas polarized light is required at the liquid crystal panel. In older projectors, this issue was not tackled and the majority of light of the wrong polarization state for the LC panel was absorbed by a polarizer, thereby contributing to severe light loss in the system. Many modem LCD projectors have a so-called polarization conversion optical system to increase the system efficiency. A polarization conversion system converts the initially un-polarized light from the lamp into polarized light, which is subsequently incident upon the liquid crystal panels. This allows almost all of the light emitted by the lamp to be processed by the liquid crystal display, thereby increasing the system efficiency and making the projector brighter.

Referring to FIG. 1, a conventional liquid crystal projection system is illustrated. The convention liquid crystal projection system comprises an oval-shaped source of light 10a, a column integrator 20a, a transparent color wheel 30a, a light transmission lens unit 40a, and a reflective liquid crystal panel 50a. At the front end of the column integrator 20a, a polarization conversion unit 21a is provided. The area of the cross section of the polarization conversion unit 21a is equal to the area of the cross section of the column integrator 20a. Light emitted from the oval-shaped source of light 10a focuses on the polarization conversion unit 21a and is converted into polarized light. The polarized light is then received by the column integrator 20a to output uniform light, which is subsequently incident upon and penetrates through the transparent color wheel 30a to become color light, which is subsequently incident upon the reflective liquid crystal panel 50 by way of the light transmission lens unit 40a. The color light is then projected by the LC projection system to show magnified images on a screen.

Referring to FIG. 2, the polarization beam splitters 22a of the polarization conversion unit 21a are arranged in a parallel manner with substantially equal pitches there-between. Each is oblique at an angle of 45 degrees relative to the light incident direction. A multi-layered material film 23a is coated on the reflection side. A ½ wavelength plate 24a is situated in each reflection light path between two polarization beam splitters 22a, as indicated. With such configuration, incident light passing through the polarization conversion unit 21a is converted into polarized light.

However, the above-described prior art projection system with a polarization conversion unit still encounters several drawbacks, which are listed below:
1. According to the prior art structure, the area of the cross section of the polarization conversion unit for receiving light is inadequate. A heat extension phenomenon occurs at the small area light-receiving cross section when the light is focused thereon and is still a severe problem. When the optic device is overheated, the multi-layered material film may be damaged. The undesired heat extension of the optic devices also results in adverse light scattering problems, leading to impure light signal output and therefore fluctuating and poor image contrast.
2. When the light emitted from the oval-shaped source of light is focused on the polarization conversion unit, light scatters in the polarization conversion unit since the incident light from the oval-shaped source of light is not parallel light. Likewise, this also results in an impure light signal after polarization conversion and poor contrast.
3. According to the prior art structure, the area of the light receiving side of the polarization conversion unit is only about half of the light receiving side of the polarization beam splitters. This exacerbates the above-mentioned heat extension problems.
4. The manufacturing processes for the above-described prior art projection system with a polarization conversion unit are complex,

In light of the foregoing, there is a strong need in the industry to provide an improved liquid crystal projection system to solve the above-mentioned problems.

### SUMMARY OF THE INVENTION

Accordingly, the primary object of the present invention is to provide a polarization conversion module, in which the optic device size is enlarged, the number of the optic devices is reduced, thereby reducing the received light intensity per unit area thereof, and at the same time, eliminating light scattering effects, therefore increasing light utilization efficiency and phase shifting efficiency, and enhancing the image contrast.

Another object of the present invention is to provide a polarization conversion module capable of paralleling the incident light, thereby reducing the possibility of light scattering that results in impure light signals.

Yet another object of the present invention is to provide a polarization conversion module having an increased light receiving cross section area, thereby alleviating or eliminating heat extension problems.

Still another object of the present invention is to provide a polarization conversion module having a simplified configuration and that is thus much more cost-effective than the prior art structures.

A further object of the present invention is to provide a method for converting polarity of light that allows a projection system to convert an incident light into mono-polarity output light.

To achieve these and other advantages and in accordance with the purposes of the present invention, as embodied and broadly described herein, the present invention provides a polarization conversion module used in a projection system to convert an incident light into polarized light. The polarization conversion module comprises a convex lens used to receive and parallel the incident light passing therethrough. A polarization beam splitter is provided for receiving and polarizing the paralleled incident light transmitted from the convex lens. The polarization beam splitter splits the paralleled incident light into two parts, one of which penetrates through the polarization beam splitter, and another part of which is reflected by the polarization beam splitter. A phase transformation device is provided for receiving the polarized light penetrating through the polarization beam splitter and transforming the phase of the polarized light passing therethrough, thereby generating phase-shifted polarized light. A mirror is provided for reflecting the reflected polarized light from the polarization beam splitter.

According to one preferred embodiment of the present invention, a method for converting polarity of light suited for projection systems to convert an incident light into mono-polarity output light is provided. The method comprises paralleling the incident light, polarizing the paralleled incident light, and secondary-reflecting the reflected polarized incident light to generate a non-phase-shifted polarized output light. During polarization, the polarized incident light is split into two parts; one part is phase-shifted as a phase-shifted polarized output light, and the other part is reflected.

### BRIEF DESCRIPTION OF THE DRAWINGS

Other objects, advantages and novel features of the invention will become more clearly and readily apparent from the following detailed description when taken in conjunction with the accompanying drawings:

FIG. 1 schematically illustrates the configuration of a prior art liquid crystal projection system;

FIG. 2 is a schematic cross-sectional diagram showing the polarization beam splitters of the polarization conversion unit, which are arranged in a parallel manner with substantially equal pitches there-between;

FIG. 3 is a schematic diagram illustrating the configuration of a liquid crystal projection system in accordance with the present invention;

FIG. 4 is a schematic diagram showing the polarization conversion of the present invention;

FIG. 5 illustrates a second preferred embodiment of the present invention;

FIG. 6 illustrates a third preferred embodiment of the present invention;

FIG. 7 illustrates a fourth preferred embodiment of the present invention; and

FIG. 8 illustrates a fifth preferred embodiment of the present invention.

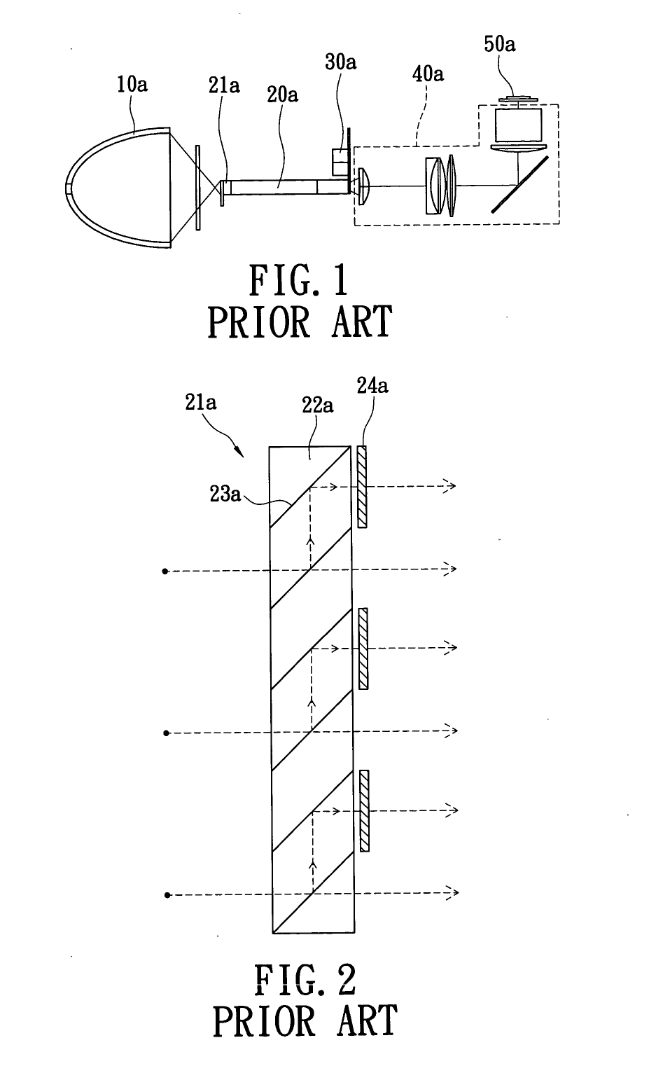

### DETAILED DESCRIPTION OF THE PREFERRED EMBODIMENTS

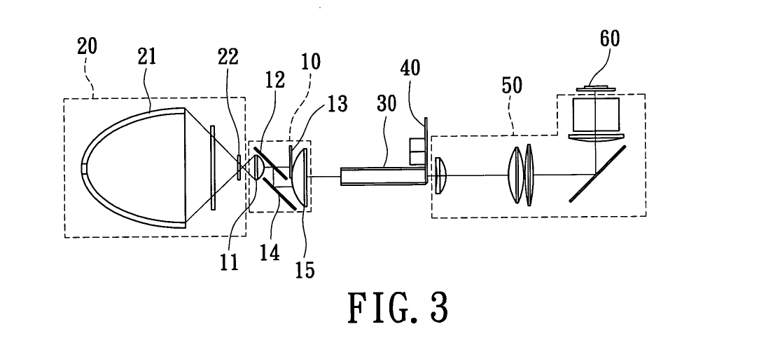

Referring initially to FIG. 3, the present invention is directed to a polarization conversion module 10, which is particularly suited for liquid crystal projection system applications, more particularly suited for single-panel liquid crystal projection systems. In accordance with the present invention, as shown in FIG. 3, the single-panel LC projection system comprises a light source unit 20, a polarization conversion module 10, a uniform-light generating unit 30, a transparent color wheel 40, a light transmission lens unit 50, and a reflective liquid crystal (LC) panel 60. The light source unit 20 includes an oval-shaped source of light 21 and an ultraviolet (UV) screen mirror 22. Light emitted from the oval-shaped source of light 21 penetrates through the UV screen mirror 22, and is then incident upon the polarization conversion module 10. The incident light signal is thereafter converted into a mono-polarity light signal by the polarization conversion module 10. The mono-polarity light is then focused on the uniform-light generating unit 30 to unify the light signal. Subsequently, the uniform light penetrates through the color wheel 40 and the light transmission lens unit 50, thereby forming a color light signal, which is projected onto the LC panel 60.

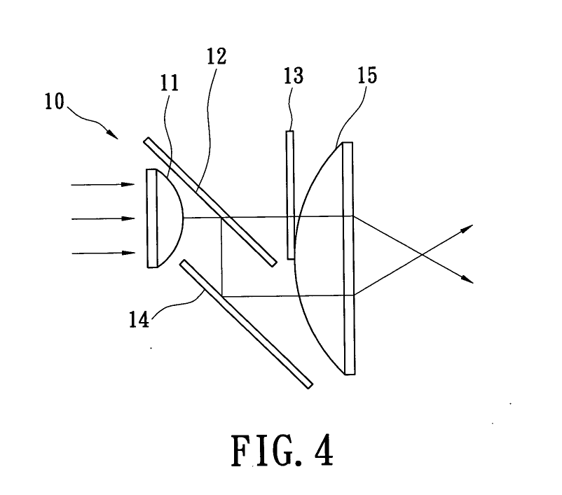

Referring to FIG. 4, the polarization conversion module 10 comprises a convex lens 11, a polarization beam splitter 12, a phase transformation device 13, a mirror 14, and a focusing lens 15. First, light penetrates through the convex lens 11 to generate parallel light. A portion of the parallel light penetrates though the polarization beam splitter 12 and is then incident upon the phase transformation device 13 to generated phase-shifted light that is then incident upon the focus lens. A portion of the parallel light from the convex lens 11 is reflected by the polarization beam splitter 12 and again reflected by the mirror for transmission to the focus lens 15. The focus lens 15 focuses the split light signals onto other devices of the projection system. By doing this, the output light signal generated by the polarization conversion module 10 is mono-polarity light. Plus, the light utilization efficiency is improved and the light signal is purified as well, thereby enhancing the image contrast. The adverse heat effects are also reduced or avoided by enlarging the size of the optic devices.

Still referring to FIG. 4, the steps of converting the light into polarized light by the polarization conversion module 10 include:
(A) Using the convex lens to parallel incident light emitted from the oval-shaped source of light 21;
(B) Using the polarization beam splitter 12 to polarize the incident light and to split the light into two parts, one of which is incident upon the phase transformation device 13. The other part of the split light is reflected.
(C) Using a mirror 14 to reflect the reflected part of the split light of step (B). The resultant light signal has mono-polarity; and
(D) Providing a focus lens for focusing light signals at a predetermined zone.

The polarization beam splitter 12 can be a polarization beam splitting plate or a prism. The phase transformation device 13 can be a ½ wavelength plate.

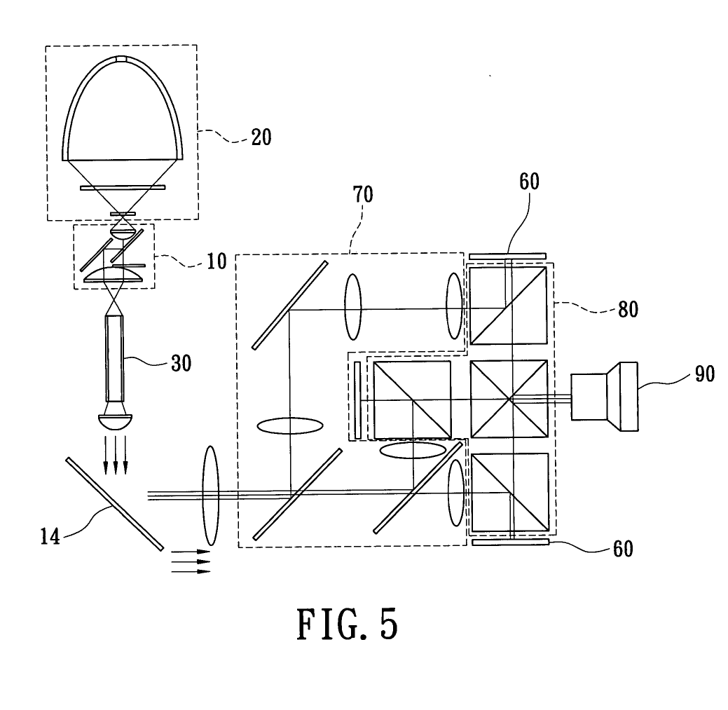

Referring to FIG. 5, another preferred embodiment of the present invention is illustrated. In this embodiment, the polarization conversion module 10 is applied in the three-panel LC projection system. Light emitted from the light source unit 20 transmits to the polarization conversion module 10 and is converted into polarized light, which is then unified by the uniform-light generating unit 30. The uniform light is transmitted to the mirror 14 and is reflected to dichroic device 70 to split the light into red (R), green (G), and blue (B) light signals, which are then incident upon a light separation/combination device 80. Separated R/G/B light beams are incident upon corresponding LC panels 60, thereby reflecting R/G/B image light signals back to the light separation/combination device 80 and recombine the R/G/B image light signals to the lens 90.

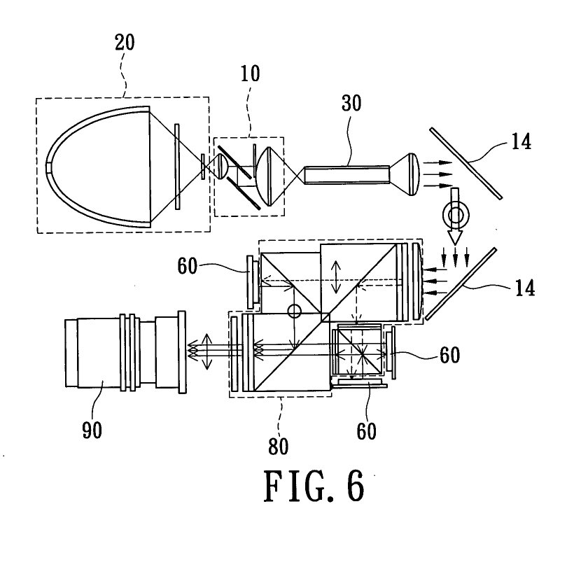

FIG. 6 illustrates a three-panel LC projection system according to another preferred embodiment of the present invention. Light emitted from the light source unit 20 transmits to the polarization conversion module 10 and is converted into polarized light, which is then unified by the uniform-light generating unit 30. The uniform light is transmitted to the mirror 14. After being reflected twice, the uniform light is transmitted to the dichroic device 70 to be split into red (R), green (G), and blue (B) light signals, which are then incident upon a light separation/combination device 80. Separated R/G/B light beams are incident upon corresponding LC panels 60, thereby reflecting R/G/B image light signals back to the light separation/combination device 80 for recombination to the lens 90.

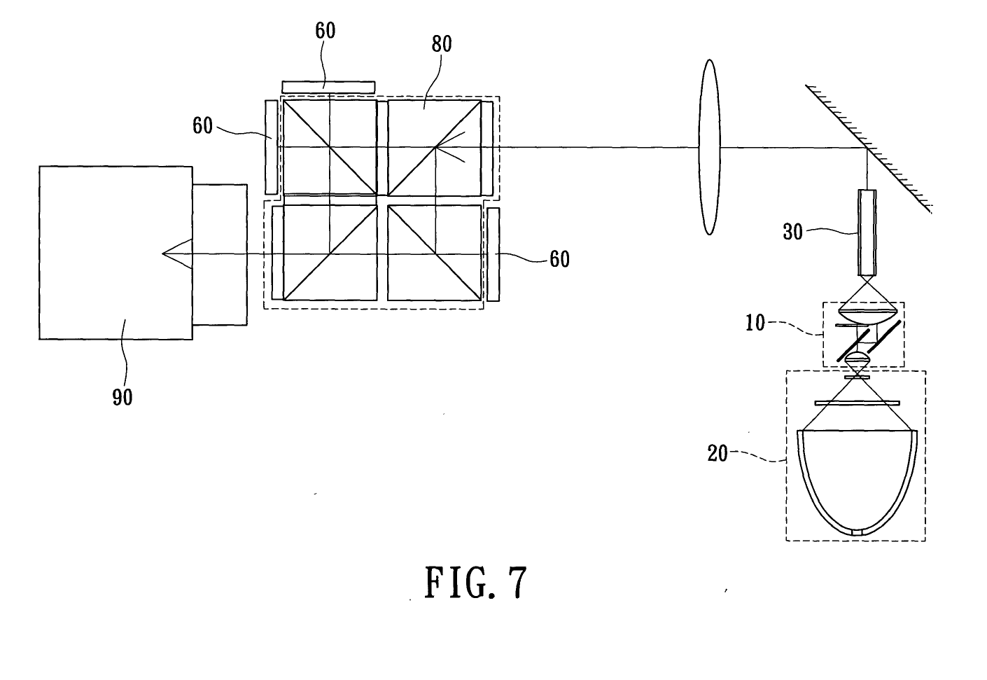

FIG. 7 illustrates a three-panel LC projection system according to another preferred embodiment of the present invention. Light emitted from the light source unit 20 is transmitted to the polarization conversion module 10 and is converted into polarized light, which is then unified by the uniform-light generating unit 30. After one reflection, the uniform light is transmitted to the light separation/combination device 80. Separated R/G/B light beams are incident upon corresponding LC panels 60, thereby reflecting R/G/B image light signals back to the light separation/combination device 80 for recombination to the lens 90.

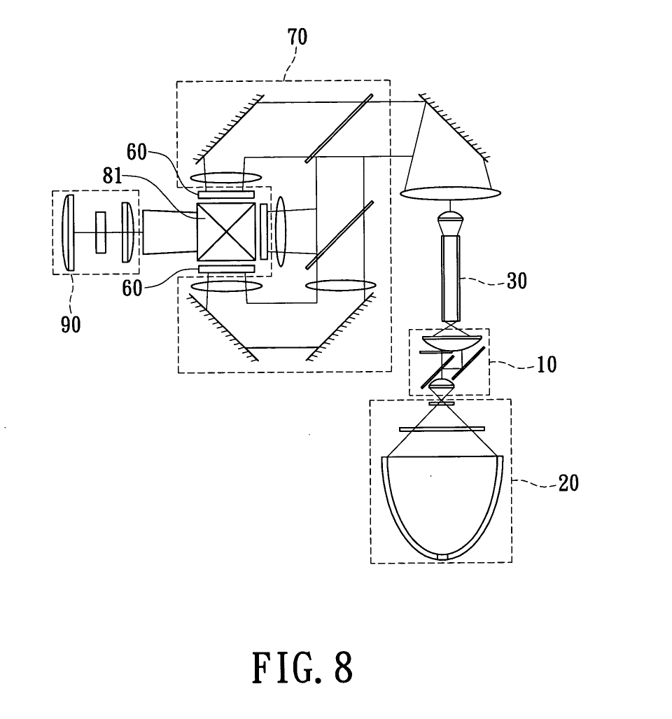

FIG. 8 illustrates a three-panel LC projection system according to another preferred embodiment of the present invention. Light emitted from the light source unit 20 is transmitted to the polarization conversion module 10 and is converted into polarized light therein. The polarized light is then unified by the uniform-light generating unit 30. After one reflection, the uniform light is transmitted to the dichroic device 70 and split into R/G/B light beams. The R/G/B light is then directed to corresponding transmission LC panels 65. R/G/B image light signals are then reflected back to the light separation/combination device 80 and are recombined. The recombined light beams are then gathered by the focus lens 90 to generate full color images.

To sum up, according to the present invention polarization conversion module and the conversion method thereof, since the size of the optic device of the module are enlarged, the number of the optic devices is reduced and the light receiving intensity per unit area of the optic device is reduced. This helps eliminate the heat extension problems encounter in the prior art structures. The light scattering problem is also solved. The phase transformation efficiency and light utilization efficiency are both enhanced.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A polarization conversion module used in a projection system to convert an incident light into polarized light, the polarization conversion module comprising:
a convex lens used to receive and parallel the incident light passing therethrough;
a polarization beam splitter for receiving and polarizing the paralleled incident light transmitted from the convex lens, wherein the polarization beam splitter splits the paralleled incident light into two parts, one part penetrating through the polarization beam splitter and another part being reflected by the polarization beam splitter;
a phase transformation device for receiving the polarized light penetrating through the polarization beam splitter and transforming the phase of the polarized light passing therethrough, thereby generating phase-shifted polarized light; and
a mirror for reflecting the reflected polarized light from the polarization beam splitter.

2. The polarization conversion module of claim 1, further comprising a focusing lens for receiving the phase-shifted polarized light from the phase transformation device and the reflected polarized light from the mirror, and projecting the received light onto a predetermined zone.

3. The polarization conversion module of claim 1, wherein the phase transformation device is a ½ wavelength plate.

4. The polarization conversion module of claim 1, wherein the polarization beam splitter is a polarization beam splitting prism.

5. The polarization conversion module of claim 1, wherein the polarization beam splitter is a polarization beam splitting plate.

6. A method for converting polarity of light, suited for projection systems to convert an incident light into mono-polarity output light, the method comprising the steps of:
paralleling the incident light;
polarizing the paralleled incident light, wherein the polarized incident light is split into two parts, one part being phase-shifted as a phase-shifted polarized output light and another part being reflected; and
secondary-reflecting the reflected polarized incident light to generate a non-phase-shifted polarized output light.

7. The method of claim 6, further comprising the step of collecting the phase-shifted polarized output light and the non-phase-shifted polarized output light and projecting them onto a predetermined zone.

8. The method of claim 7, wherein the method of collecting the phase-shifted polarized output light and the non-phase-shifted polarized output light is to use a focusing lens.

9. The method of claim 6, wherein a convex lens is used in the step of paralleling the incident light.

10. The method of claim 6, wherein the step of polarizing the paralleled incident light involves the use of a polarization beam splitter.

11. The method of claim 6, wherein the polarized incident light is phase shifted by using a phase transformation device.

12. The method of claim 6, wherein the step of secondary-reflecting the reflected polarized incident light to generate a non-phase-shifted polarized output light involves the use of a mirror.
